(19) United States
(12) Patent Application Publication
(10) Pub. No.: US 2006/0014035 A1
(43) Pub. Date: Jan. 19, 2006

(54) Polyamide-based multilayer structure for covering substrates

(76) Inventors: Thibaut Montanari, Bernay (FR); Christophe Lacroix, Mareil Sur Mauldre (FR); David Silagy, Evreux (FR); Jocelyn Mauffrey, Beaumesnil (FR); Roparz Kervennal, Douarnenez (FR); Martin Baumert, Serquigny (FR)

Correspondence Address: Arkema Inc., 2000 Market St., Philadelphia, PA, 19103, US

(21) Appl. No.: 11/154,420

(22) Filed: Jun. 16, 2005

Related U.S. Application Data
(60) Provisional application No. 60/604,795, filed on Aug. 26, 2004.

(30) Foreign Application Priority Data
Jun. 22, 2004 (FR) 04.06756

(51) Int. Cl. B32B 27/08

(52) U.S. Cl. 428/474.4

(57) ABSTRACT

The present invention relates to a polyamide-based multilayer structure comprising in succession: an upper layer made of a transparent polyamide coming from the condensation: either of a lactam or of an α,Ω-amino acid having at least 9 carbon atoms or of a diamine and of a diacid, at least one having at least 9 carbon atoms; a lower layer capable of adhering to the substrate and optionally, an intermediate tie layer (also called a central layer) between the upper layer and the lower layer, each of the layers exhibiting thermomechanical behaviour (strength as a function of temperature) sufficiently similar to allow the structure to be easily formed under the effect of the temperature. The invention also relates to the objects consisting of these substrates covered with these structures, the lower layer being placed against the substrate.

This application claims benefit, under U.S.C. §119(a) of French National Application Number 04.06756, filed Jun. 22, 2004, and also claims benefit, under U.S.C. § 119(e) of U.S. provisional application 60/604795, filed Aug. 26, 2004, incorporated herein by reference.

### FIELD OF THE INVENTION

The present invention relates to a polyamide-based multilayer structure for covering substrates. This aesthetic and resistant multilayer structure, which may or may not be formed beforehand by thermoforming, is intended to be combined with/fastened to a substrate (typically a rigid substrate) during an overmoulding or lamination operation, or the like. It comprises an upper layer (or face) and a lower layer (or face)—it is the lower layer that is placed against the substrate. The structure is also called a film or sheet when its thickness is at most around 0.5 to 1 mm. The structure is placed in an injection mould, the upper layer being placed on the mould wall side, and then the substrate in the melt state is injected on the lower layer side. The structure may be thermoformed before being placed in the mould. After the mould has cooled down and been opened, the substrate covered with the structure is recovered.

### BACKGROUND OF THE INVENTION

A multilayer structure must possess all the following advantages:

It must have an upper face with an attractive surface appearance, for example a very shiny one, or, on the contrary, a matt one, that is to say have an upper face that can easily render surface finishes or take a grain, that is to say is capable of becoming smooth and shiny (in contact with a sufficiently hot polished metal mould wal) or of becoming matt and grained (on contact with a sufficiently hot matt or grained metal mould wall), or of assuming a brushed appearance. Typically and preferably, the surface appearance is given during manufacture of the object, preferably during the last step at a temperature above Tg, for example during overmoulding of the sheet.

It must have an upper face that presents attractive colour rendering (the upper face therefore being really transparent so that the underlying colour presents a depth effect and a varnished appearance).

It must have an upper face resistant to mechanical attack: impact, abrasion (sand or scrubbing brush), knocks, cutting; (optionally even able to be repaired/reshone by flame brushing the surface). This resistance is meant from the standpoint of a low loss of material and from the aesthetic standpoint, that is to say the mechanical attack is barely visible, for example no ravelling.

It must have an upper face resistant to chemical attack and to stress cracking. Chemical resistance means, for example, resistance to cleaning products and solvents, to oils, such as for example motor vehicle engine oils, to motor vehicle windscreen-washer fluids, and to battery fluids.

It must have an upper face resistant to attack by UV solar radiation (little yellowing, mechanical behaviour maintained).

It must have an upper face that can subsequently be repaired, more precisely reshone by a simple surface heating operation, for example by flame brushing—this advantage is preferred but is not essential.

It must exhibit thermomechanical behaviour conducive to thermoforming, especially by being easily hot-deformable while still being below its melting point.

It must have an upper face that does not deform unacceptably due to the effect of a hot environment.

It must have an upper face that does not deform unacceptably due to the effect of moisture, and the physical and chemical properties of which vary only moderately with moisture.

It must have a lower face capable of adhering to a substrate, the latter typically being introduced through an overmoulding step, this substrate typically being PP, PA-6 or a styrene polymer such as ABS, which polymers are typically reinforced by glass fibres or mineral fillers. This substrate is needed to obtain a sufficiently rigid finished part (a body wing, engine cover, portion of a dashboard). Other substrates and other combining techniques may also be envisaged; for example as regards substrates, mention may be made of metal meshes, mats, fibres, composites. For example as regards techniques for combining the sheet with these substrates, mention may be made of lamination.

It must comprise a sheet all of whose layers adhere well and lastingly to one another.

Advantageously, but not necessarily, the upper face may be sublimation decorated (or indeed by any other process).

Advantageously, but not necessarily, the lower face may be sublimation decorated or decorated by screen printing (or indeed by any other process).

The prior art has described visible parts whose external face (also called the upper face) consists of an amorphous polymer such as polycarbonate (PC), PMMA and MABS (an MMA-acrylonitrile-butadiene-styrene copolymer). These parts have a poor chemical resistance, a poor stress cracking resistance and poor UV resistance.

The prior art has described visible parts whose external face consists of a paint and/or a varnish. The impact strength is higher than in the previous prior art, but there is a solvent problem associated with the varnish.

The prior art has described visible parts whose external face consists of a semicrystalline polymer of the type consisting of PA-6, PA-6,6 and alloys thereof. The surface appearance is unattractive—there are too many dimensional variations due to the high water pick up of C6 polyamides. In addition, the ZnCl₂ resistance of these PAs is limited.

The prior art has described visible parts whose external face consists of a semicrystalline polymer of the type comprising PVDF and its alloys with PMMA. However, these products are not capable of easily taking a grain or rendering surface finishes; in addition, the scratch resistance is inferior to that of a polyamide.

The prior art has described visible parts whose external face consists of a semicrystalline polymer of the type comprising polypropylene, polyacetal (POM), PBT and alloys thereof. The surface appearance is unattractive and the chemical resistance is moderate.

### SUMMARY OF THE INVENTION

The present invention relates to a polyamide-based multilayer structure comprising in succession:

an upper layer made of a transparent polyamide coming from the condensation:
either of a lactam or of an α,Ω-amino acid having at least 9 carbon atoms or of a diamine and of a diacid, at least one having at least 9 carbon atoms;

a lower layer capable of adhering to the substrate; and

optionally, an intermediate tie layer (also called a central layer) between the upper layer and the lower layer,

each of the layers exhibiting thermomechanical behaviour (strength as a function of temperature) sufficiently similar to allow the structure to be easily formed under the effect of the temperature.

The upper layer is made of one or more polyamides with a high carbon number in order to limit the water uptake and the dimensional variations, and to improve the chemical resistance. Advantageously, it is highly transparent (in appearance). The term “highly transparent” is understood to mean a transparency of 80% or higher light transmission on an object 2 mm in thickness at a wavelength of 560 nm (cf. ISO 13468). The term “transparent” is understood to mean a transparency of 50% or higher light transmission on an object 2 mm in thickness at a wavelength of 560 nm (cf ISO 13468). Preferably, it is semicrystalline, which results in good chemical resistance, UV resistance and abrasion resistance. It is sufficiently ductile and flexible over a large temperature range (impact, thermoformability, grained or polished surface), but nevertheless sufficiently rigid (scratch resistance) and nevertheless having a melting point (or if not a glass transition temperature) high enough for it not to creep excessively at a high temperature. A transparent microcrystalline PA (for example the compositions described in U.S. patent applications 2002173596 and 2002179888) is most particularly preferred as it also has the advantage of being completely transparent and the advantage of presenting a very attractive surface finish, which reproduces much more faithfully the surface finish of the mould. If the mould is polished, the final surface finish will be highly polished, smooth and shiny. If the mould is matt, the final surface finish will be matt. If the mould is grained, the final surface finish will be grained. If the mould is brushed, the final surface finish will be brushed. It therefore has the advantage of being able to render surface finishes, such as for example those of metals and wood, particularly well.

The lower layer is either of the same nature as the substrate (it therefore will adhere in the hot or melt state to this substrate) or is capable of adhering chemically or physically to this substrate. The substrate may, for example, be either PP, or PA-6 or PA-6,6, or a styrene polymer such as ABS. Mention may also be made of thermosets and composites (for example epoxy/glass fibre composite), wovens or nonwovens made of glass, carbon or other fibres, metal meshes and substrates painted by lacquers and paints (epoxy, polyurethane, etc.).

The optional intermediate tie layer promotes adhesion between the upper and lower layers, this intermediate layer not being essential if the lower and/or upper layers are formulated in such a way that there is direct adhesion between them.

Each of the layers exhibits thermomechanical behaviour (stiffness as a function of temperature) that is sufficiently similar so as to allow the structure to be easily formed through the effect of temperature (thermoforming or forming during the overmoulding) and not to deform unacceptably during the subsequent life of the part. This behaviour is defined by DMA (Dynamic Mechanical Analysis) or their flexural modulus measured at the temperatures in question (ISO 178). Advantageously, the melting points or glass transition temperatures of the various layers differ by at most 25 to 50° C. If one of the layers does not meet these favourable criteria sufficiently closely, a sufficiently small thickness so that its behaviour has a sufficiently little effect on the behaviour of the overall multilayer structure is used for it. It should be pointed out that should the difference in thermomechanical behaviour be a little too pronounced, an adjustment may be made by increasing the relative thickness of one of the layers so that the thermomechanical behaviour of this other layer is predominant in the structure.

The structures are preferably produced by extrusion-calendering (thickness from 50 to 3000 μm), or by extrusion-casting (also called film casting, thickness from 10 to 500 μm) or by tubular (bubble) extrusion blowing (thickness 10 μm to 300 μm). These structures are then typically thermoformed (if they are sufficiently thick and if the downstream steps so require). The structures are then typically placed in a mould of an injection moulding machine (since the structures may or may not have been thermoformed beforehand, this thermoforming is preferable in the case of quite thick structures) and the substrate is then overmoulded onto the structure. Overmoulding is a typical process, but other processes for assembling the film and the substrate may be considered.

The invention also relates to the objects formed from these substrates covered with these structures, the lower layer being placed against the substrate.

### DETAILED DESCRIPTION OF THE INVENTION

With regard to the polyamide of the upper layer, in a first embodiment, mention may be made of polyamides that result from the condensation of at least one diamine chosen from aliphatic, aromatic, arylaliphatic and cycloaliphatic diamines, and of at least one diacid chosen from aliphatic, aromatic, arylaliphatic and cycloaliphatic diacids, at least one of the diamines or diacids being aromatic, arylaliphatic or cycloaliphatic.

As an example of this first embodiment (type 1), mention may be made of polyamides coming from the condensation of at least one aromatic diacid, of a diamine and optionally of a lactam (or of an α,Ω-amino acid). The aromatic diacid may be chosen from isophthalic acid and terephthalic acid. Such polyamides are described in Patents U.S. Pat. No. 4,898,896, EP 553 581, U.S. Pat. No. 5,416,172 and U.S. Pat. No. 5,310,860. These polyamides are in general amorphous—they may be slightly crystalline if they contain a high proportion of aliphatic monomer.

Mention may also be made by way of example of this first embodiment (type 2) of transparent amorphous polyamides that result from the condensation:

of at least one diamine chosen from aromatic, arylaliphatic and cycloaliphatic diamines and

of an aliphatic diacid having at least 8 and advantageously at least 9 carbon atoms.

Cycloaliphatic diamines having two cycloaliphatic rings are preferred. These diamines satisfy the general formula (I) 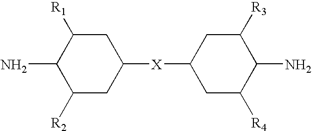
in which R1 to R4 represent identical or different groups chosen from a hydrogen atom or alkyl groups having from 1 to 6 carbon atoms, and X represents either a single bond or a divalent group consisting of:

a linear or branched aliphatic chain having from 1 to 10 carbon atoms;

a cycloaliphatic group having from 6 to 12 carbon atoms;

a linear or branched aliphatic chain having from 1 to 10 carbon atoms, the said chain being substituted with cycloaliphatic groups having from 6 to 8 carbon atoms;

a group having 8 to 12 carbon atoms, consisting of a linear or branched dialkyl, with a cyclohexyl or benzyl group.

Mention may be made by way of example of 4,4′-methylene-bis(cyclohexylamine) or p-bis(aminocyclohexyl)methane often referred to by the name PACM. Mention may also be made of 2,2′-dimethyl-4,4′methylene-bis(cyclohexylamine) or bis-(3-methyl-4-aminocyclohexyl)methane, often referred to by the name BMACM. As examples of polyamides, mention may be made of PACM.12 and BMACM.12, in which “12” denotes dodecanedioic acid.

These products are described in Patents EP 725 101, EP 619 336 and EP 136 947. Other similar polyamides are described in Patents EP 1 341 849, EP 1 130 059, EP 985 709, EP 885 930, EP 848 034, EP 725 100, EP 603 813, FR 2 606 416, FR 2 575 756, U.S. Pat. No. 6,277,911, U.S. Pat. No. 6,008,288, U.S. Pat. No. 5,886,087, U.S. Pat. No. 5,696,202, U.S. Pat. No. 5,684,120, U.S. Pat. No. 5,773,558, U.S. Pat. No. 5,700,900, U.S. Pat. No. 5,288,799, U.S. Pat. No. 5,177,177, U.S. Pat. No. 5,321,119, U.S. Pat. No. 4,847,356 and U.S. Pat. No. 4,731,421.

With regard to the polyamide of the upper layer, in a second embodiment, mention may be made of semicrystalline PAs. As examples of semicrystalline polyamides, mention may be made of aliphatic polyamides. The aliphatic polyamides may be chosen from PA-11 and PA-12, the aliphatic polyamides resulting from the condensation of an aliphatic diamine having from 6 to 12 carbon atoms and of an aliphatic diacid having from 9 to 12 carbon atoms, and 11/12 copolyamides having either more than 90% 11 units or more than 90% 12 units.

As examples of aliphatic polyamides resulting from the condensation of an aliphatic diamine having from 6 to 12 carbon atoms and of an aliphatic diacid having from 9 to 12 carbon atoms, mention may be made of:

PA-6,12 resulting from the condensation of hexamethylenediamine and of 1,12-dodecanedioic acid;

PA-9,12 resulting from the condensation of the C9 diamine and of 1,12-dodecanedioic acid;

PA-10,10 resulting from the condensation of the C10 diamine and of 1,10-decanedioic acid; and

PA-10,12 resulting from the condensation of the C9 diamine and of 1,12-dodecanedioic acid.

As regards the 11/12 copolyamides having either more than 90% 11 units or more than 90% 12 units, these result from the condensation of 1-amino undecanoic acid with lauryllactam (or the C12 α,Ω-amino acid).

The polyamide layer may also comprise copolymers having polyamide blocks and polyether blocks, but it is advantageous for these to be in proportions that do not impair the transparency of this layer.

These semicrystalline polyamides are formed between their T_{g} (glass transition temperature) and their Tₘ (melting point). This forming consists, for example in thermoforming and overmoulding. As an example, the T_{g} is around 60° C. and the melting point is around 190° C. They are rigid at the use temperatures, i.e. below T_{g}—these temperatures are for example between −40° C. and 60° C.

In this second embodiment, among semicrystalline polyamides those that are microcrystalline are preferred, that is to say those consisting of crystalline structures (spherulites) having a size small enough not to diffract light and thus allow good transparency. In the rest of the text, these will be referred to as “microcrystalline” polyamides. Among these microcrystalline polyamides, it is preferred to use those whose T_{g} (glass transition temperature) is between 40° C. and 90° C. and whose Tₘ (melting point) is between 150° C. and 200° C., whose degree of crystallinity is greater than 10% (1st DSC heating according to ISO 11357 at 40° C./min) and whose melting enthalpy is greater than 25 J/g (1st DSC heating according to ISO 11357 at 40° C./min).

These microcrystalline polyamides are malleable, flexible and workable, and they are formed, when hot, between T_{g} and Tₘ, for example between 60 and 190° C. This temperature range is that at which the thermoforming and the overmoulding are carried out. Crystalline polyamides are too rigid at these temperatures and many amorphous polyamides melt at these temperatures. These microcrystalline polyamides are quite rigid, hard (abrasion resistant) and durable at temperatures below T_{g}, which are the use/service temperatures. They are around −40° C. to +60° C.

This type of product is most particularly preferred as it also has the advantage of being completely transparent and the advantage of presenting a very attractive surface finish, which reproduces much more faithfully the surface finish of the mould. If the mould is polished, the final surface finish will be highly polished, smooth and shiny. If the mould is matt, the final surface finish will be matt. If the mould is grained, the final surface finish will be grained. If the mould is brushed, the final surface finish will be brushed. It therefore has the advantage of being able to render the surface finishes of metals, wood, etc. particularly well.

By way of examples of microcrystalline polyamides, mention may be made of a transparent composition comprising, by weight, the total being 100%:

5 to 40% of an amorphous polyamide (B) that results essentially from the condensation:
either of at least one diamine chosen from cycloaliphatic diamines and aliphatic diamines and of at least one diacid, chosen from cycloaliphatic diacids and aliphatic diacids, at least one of these diamine or diacid units being cycloaliphatic
or of a cycloaliphatic α,Ω-aminocarboxylic acid
or of a combination of these two possibilities and
optionally of at least one monomer chosen from α,Ω-aminocarboxylic acids or the possible corresponding lactams, aliphatic diacids and aliphatic diamines;

0 to 40% of a flexible polyamide (C) chosen from copolymers having polyamide blocks and polyether blocks, and copolyamides;

0 to 20% of a compatibilizer (D) for (A) and (B);

0 to 40% of a flexible modifier (M);

with the condition that (C)+(D)+(M) is between 0 and 50%;

the remainder to 100% of a semicrystalline polyamide (A).

For simplification in the rest of the text, this polyamide will be referred to as “microcrystalline polyamide of type 1”. This is easily manufactured since the temperature above which a transparent material forms is low enough to be very close and even identical to, or even below, the usual temperature at which (A) is compounded (melt blending in an extruder or a mixer). Typically, this temperature is in the region of 270° C. This temperature is lower the larger the amount of (D). The advantage of such a temperature is that this material can be produced under standard compounding conditions, there is no degradation, the composition does not yellow, there are few or no black spots or gels, and the composition can be more easily recycled (it can be reused more easily). This composition is microcrystalline.

These microcrystalline polyamides of type 1 will now be described in greater detail.

With regard to the semicrystalline polyamide (A), mention may be made of (i) aliphatic polyamides, which are products resulting from the condensation of an aliphatic α,Ω-aminocarboxylic acid, of a lactam or the products resulting from the condensation of an aliphatic diamine and of an aliphatic diacid and (ii) other polyamides, provided that they are semicrystalline. Among these other semicrystalline polyamides, it is preferred to use those that have sufficiently small crystalline structures so as to be almost transparent.

By way of examples of aliphatic α,Ω-aminocarboxylic acids, mention may be made of aminocaproic, 7-aminoheptanoic, 11-aminoundecanoic and 12-aminododecanoic acids. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of aliphatic diacids, mention may be made of adipic, azelaic, suberic, sebacic and dodecanedicarboxylic acids.

Among aliphatic polyamides, mention may be made by way of example and non-limitingly, of the following polyamides: polyundecanamide (PA-11); polylauryllactam (PA-12); polyhexamethyleneazelamide (PA-6,9); polyhexamethylenesebacamide (PA-6,10); polyhexamethylenedodecanamide (PA-6,12); polydecamethylenedodecanamide (PA-10,12); polydecamethylenesebacanamide (PA-10,10) and polydodecamethylenedodecanamide (PA-12,12).

Advantageously (A) comes from the condensation of a lactam having at least 9 carbon atoms, of an α,Ω-aminocarboxylic acid having at least 9 carbon atoms or of a diamine and of a diacid, such that the diamine or the diacid has at least 9 carbon atoms. Advantageously (A) is PA-11 and PA-12, and preferably PA-12. It would not be outside the scope of the invention if (A) were to be a blend of aliphatic polyamides.

With regard to the amorphous polyamide with a cycloaliphatic unit (B), the cycloaliphatic diamines may be isomers of bis(4-aminocyclohexyl)methane (BACM), bis(3-methyl-4-aminocyclohexyl)methane (BMACM), 2,2-bis(3-methyl-4-aminocyclohexyl)propane (BMACP), and para-aminodicyclohexylmethane (PACM). The other diamines commonly used may be isophoronediamine (IPDA) and 2,6-bis(aminomethyl)norbomane (BAMN). The aliphatic diacids were mentioned above. As an example, mention may be made of PA-IPDA,12 that results from the condensation of isophoronediamine with dodecanedicarboxylic acid. The amorphous polyamide (B) may optionally contain at least one monomer or comonomer chosen from:

α,Ω-aminocarboxylic acids;

aliphatic diacids;

aliphatic diamines;

these products were described above. As examples of (B), mention may be made of PA-IPDA,10, coPA-IPDA,10/12, and PA-IPDA,12. It would not be outside the scope of the invention if (B) were to be a blend of several amorphous polyamides.

With regard to the flexible polyamide (C) and firstly the copolymers having polyamide blocks and polyether blocks, these result from the copolycondensation of polyamide blocks having reactive ends with polyether blocks having reactive ends, such as, inter alia:

1) polyamide blocks having diamine chain ends with polyoxyalkylene blocks having dicarboxylic chain ends;

2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols;

3) polyamide blocks having dicarboxylic chain ends with polyetherdiols, the products obtained being, in this particular case, polyetheresteramides. Advantageously, the copolymers (c) are of this type.

Polyamide blocks having dicarboxylic chain ends derive, for example, from the condensation of alpha, omega-aminocarboxylic acids, of lactams or of dicarboxylic acids and diamines in the presence of a chain-stopping dicarboxylic acid.

The number-average molar mass \overline{M}ₙ of the polyamide blocks is between 300 and 15 000 and preferably between 600 and 5000. The mass \overline{M}ₙ of the polyether blocks is between 100 and 6000 and preferably between 200 and 3000.

Polymers having polyamide blocks and polyether blocks may also include randomly distributed units. These polymers may be prepared by the simultaneous reaction of the polyether and polyamide-block precursors.

For example, it is possible to react polyetherdiol, a lactam (or an alpha, omega-amino acid) and a chain-stopping diacid in the presence of a small amount of water. A polymer is obtained having essentially polyether blocks and polyamide blocks of very variable length, but also the various reactants, having reacted in a random fashion, which are distributed randomly along the polymer chain.

These polymers having polyamide blocks and polyether blocks, whether they derive from the copolycondensation of polyamide and polyether blocks prepared beforehand or from a one-step reaction, have, for example, Shore D hardnesses which may be between 20 and 75 and advantageously between 30 and 70 and an intrinsic viscosity of between 0.8 and 2.5 measured in meta-cresol at 25° C. for an initial concentration of 0.8 g/100 ml. The MFIs may be between 5 and 50 (235° C., with a load of 1 kg).

The polyetherdiol blocks are either used as such and copolycondensed with polyamide blocks having carboxylic ends or they are aminated in order to be converted into polyetherdiamines and condensed with polyamide blocks having carboxylic ends. They may also be mixed with polyamide precursors and a chain stopper in order to make polyamide-block and polyether-block polymers having randomly distributed units.

With regard to the flexible polyamide (C) consisting of a copolyamide this results either from the condensation of at least one α,Ω-aminocarboxylic acid (or a lactam), at least one diamine and at least one dicarboxylic acid, or from the condensation of at least two α,Ω-aminocarboxylic acids (or their possible corresponding lactams or of a lactam and of the other in the form of an α,Ω-aminocarboxylic acid). These constituents are already described above.

By way of examples of copolyamides, mention may be made of copolymers of caprolactam and lauryllactam (PA-6/12), copolymers of caprolactam, adipic acid and hexamethylenediamine (PA-6/6,6), copolymers of caprolactam, lauryllactam, adipic acid and hexamethylenediamine (PA-6/12/6,6), copolymers of caprolactam, lauryllactam, 11-aminoundecanoic acid, azelaic acid and hexamethylenediamine (PA-6/6,9/11/12), copolymers of caprolactam, lauryllactam, 11-aminoundecanoic acid, adipic acid and hexamethylenediamine (PA-6/6,6/11/12), and copolymers of lauryllactam, azelaic acid and hexamethylenediamine (PA-6,9/12). The preferred copolyamides are copolyamides with a pronounced copolymer character, that is to say with essentially equivalent proportions of the various comonomers, which results in properties furthest away from the corresponding polyamide homopolymers. It would not be outside the scope of the invention if (C) were to be a blend of several copolymers having polyamide blocks and polyether blocks, or a blend of several copolyamides or any combination of these options.

With regard to the compatibilizer (D) for (A) and (B), this is any product that lowers the temperature needed to make the blend of (A) and (B) transparent. Advantageously, this is a polyamide. For example, if (A) is PA-12, then (D) is PA-11. Preferably, this is a catalyzed aliphatic polyamide.

With regard to the catalyzed polyamide (D), this is a polyamide as described above in the case of (A), but containing a polycondensation catalyst such as a mineral or organic acid, for example phosphoric acid. The catalyst may be added to the polyamide (D) after it has been prepared by any method, or, quite simply, and preferably, this may be the rest of the catalyst used for its preparation. The term “catalyzed polyamide” means that the chemistry will be continued beyond the steps of synthesizing the base resin and therefore during the subsequent steps in the preparation of the compositions of the invention. Very substantial polymerization and/or depolymerization reactions may take place during the blending of the polyamides (A) and (B) and (D) in order to prepare the compositions of the present invention. Typically, the Applicant believes (without being tied down to this explanation), that polymerization (chain extension) and chain branching (for example, bridging via phosphoric acid) continue to take place. In addition, this may be considered as a tendency toward re-equilibration of the polymerization equilibrium, and therefore a kind of homogenization. However, it is recommended that the polyamides be thoroughly dried (and advantageously the moisture contents properly controlled) in order to prevent any depolymerization. The amount of catalyst may be between 5 ppm and 15 000 ppm of phosphoric acid with respect to the resin (D). For other catalysts, for example boric acid, the contents will be different and may be chosen appropriately, according to the usual techniques for the polycondensation of polyamides.

With regard to the flexible modifier (M), mention may be made, by way of example, of functionalized polyolefins, grafted aliphatic polyesters, copolymers having polyether blocks and polyamide blocks, these optionally being grafted, copolymers of ethylene with an alkyl (meth)acrylate and/or with a vinyl ester of saturated carboxylic acid. The copolymers having polyether blocks and polyamide blocks may be chosen from those mentioned above in the case of (C), preferably flexible copolymers being chosen, that is to say those having a flexural modulus of less than 200 MPa.

The modifier may also be a polyolefin chain with polyamide or polyamide oligomer grafts; thus, it has affinity with polyolefins and with polyamides.

The flexible modifier may also be a block copolymer having at least one block compatible with (A) and at least one block compatible with (B).

As examples of flexible modifiers, mention may also be made of:

copolymers of ethylene with an unsaturated epoxide and optionally with an ester or an unsaturated carboxylic acid salt or with a vinyl ester of a saturated carboxylic acid. These are, for example, ethylene/vinyl acetate/glycidyl(meth)acrylate copolymers or ethylene/alkyl (meth)-acrylate/glycidyl(meth)acrylate copolymers;

copolymers of ethylene with an unsaturated carboxylic acid anhydride and/or with an unsaturated carboxylic acid that can be partly neutralized by a metal (Zn) or an alkaline metal (Li) and optionally with an ester of unsaturated carboxylic acid or with a vinyl ester of saturated carboxylic acid. These are, for example, ethylene/vinyl acetate/maleic anhydride copolymers or ethylene/alkyl (meth)acrylate/maleic anhydride copolymers or else ethylene/Zn or Li (meth)acrylate/maleic anhydride copolymers; and

polyethylene, polypropylene, ethylene-propylene copolymers, these being grafted or copolymerized with an unsaturated carboxylic acid anhydride and then condensed with a monoaminated polyamide (or a polyamide oligomer). These products are described in EP 342 066.

Advantageously, the functionalized polyolefin is chosen from ethylene/alkyl (meth)acrylate/maleic anhydride copolymers, ethylene/vinyl acetate/maleic anhydride copolymers and ethylene-propylene copolymers, in which propylene is predominant, these copolymers being grafted by maleic anhydride and then condensed with monoaminated polyamide 6 or monoaminated oligomers of caprolactam.

Preferably, this is an ethylene/alkyl (meth)acrylate/maleic anhydride copolymer comprising up to 40 wt % of alkyl (meth)acrylate and up to 10 wt % of maleic anhydride. The alkyl (meth)acrylate may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

As examples of grafted aliphatic polyesters, mention may be made of polycaprolactone grafted with maleic anhydride, glycidyl methacrylate, vinyl esters or styrene. These products are described in Application EP 711 791.

It is recommended to choose a flexible modifier that does not reduce the transparency of the composition. The advantage of the compositions (A)+(B), (A)+(B)+(C) and (A)+(B)+(C)+(D) mentioned above is that they have a resulting refractive index close to most of the modifiers (M) mentioned. It is therefore possible to add a modifier (M) with the same (or very similar) refractive index. This was not the case with the transparent polyamide compositions cited in the prior art, since their refractive indices are typically higher than the refractive index of the most usual modifiers (M).

In general, the modifier (M) is useful for further softening, or for conferring a particular property (hence being called a modifier) without thereby losing the advantageous properties of transparency, low-temperature manufacture and sublimation capability. Among these additional properties that the modifier may provide, we mention the following: an impact modifier for improving the impact resistance; a modifier carrying reactive functional groups in order to improve the adhesion of the material to substrates; a modifier for giving a matt appearance; a modifier for giving a silky or slippery feel; a modifier for making the material more viscous, so as to process it by blow moulding.

It is advantageous to blend the modifiers so as to combine their effects.

Advantageous compositions are those whose proportions of the constituents are the following (the total being 100%) and are described in Table 1 below:

TABLE 1

| A | B | C + D + M | C | D | M |
|---|---|---|---|---|---|
| balance to | 5 to 40 | 0 to 50 | 0 to 40 | 0 to 20 | 0 to 40 |
| 100% | | | | | |
| balance to | 20 to 30 | 0 to 50 | 0 to 40 | 0 to 20 | 0 to 40 |
| 100% | | | | | |
| balance to | 5 to 40 | 0 to 30 | 0 to 30 | 0 to 20 | 0 to 30 |
| 100% | | | | | |
| Balance to | 10 to 30 | 0 to 30 | 0 to 30 | 0 to 20 | 0 to 30 |
| 100% | | | | | |
| balance to | 20 to 30 | 0 to 30 | 0 to 30 | 0 to 20 | 0 to 30 |
| 100% | | | | | |
| balance to | 10 to 30 | 0 to 20 | 0 to 20 | 0 to 20 | 0 to 20 |
| 100% | | | | | |
| balance to | 10 to 30 | 5 to 15 | 0 to 15 | 0 to 15 | 0 to 15 |
| 100% | | | | | |
| balance to | 20 to 30 | 0 to 20 | 0 to 20 | 0 to 20 | 0 to 20 |
| 100% | | | | | |
| balance to | 20 to 30 | 5 to 15 | 0 to 15 | 0 to 15 | 0 to 15 |
| 100% | | | | | |

These compositions are manufactured by melt-blending the various constituents (in a twin-screw, BUSS® or single-screw extruder) using standard techniques for thermoplastics. The compositions may be granulated, for subsequent use (it is sufficient to remelt them) or else then injection-moulded in a mould or an extrusion or coextrusion device for manufacturing sheet or film. A person skilled in the art can readily adjust the compounding temperature in order to obtain a transparent material; as a general rule, it is sufficient to increase the compounding temperature, for example to about 280 or 290° C.

These compositions may include thermal stabilizers, antioxidants, UV stabilizers.

By way of example of microcrystalline polyamides, mention may be made of a transparent composition comprising, by weight, the total being 100%:

5 to 40% of an amorphous polyamide (B) that results essentially from the condensation of at least one optionally cycloaliphatic diamine, of at least one aromatic diacid and optionally of at least one monomer chosen from:
α,Ω-aminocarboxylic acids,
aliphatic diacids,
aliphatic diamines;

0 to 40% of a flexible polymer (C) chosen from copolymers having polyamide blocks and polyether blocks, and copolyamides;

0 to 20% of a compatibilizer (D) for (A) and (B),

(C)+(D) is between 2 and 50%;

with the condition that (B)+(C)+(D) is not less than 30%,

the balance to 100% of a semicrystalline polyamide (A).

The above polyamide will be denoted in the rest of the text, for simplification, by the term “microcrystalline polyamide of type 2”. It differs from the previous one essentially by the nature of (B) and to a lesser extent by the proportions of the constituents. It is prepared in the same way and is microcrystalline.

Advantageously, the proportion of (B) is between 10 and 40%, and preferably between 20 and 40%. Advantageously, the proportion of (C)+(D) is between 5 and 40%, and preferably 10 and 40%.

With regard to the amorphous polyamide (B) in the microcrystalline polyamide composition of type 2, this essentially results from the condensation of at least one optionally cycloaliphatic diamine and of at least one aromatic diacid. Examples of aliphatic diamines were mentioned above; the cycloaliphatic diamines may be isomers of bis(4-aminocyclohexyl)methane (BACM), bis(3-methyl-4-aminocyclohexyl)methane (BMACM), and 2,2-bis(3-methyl-4-aminocyclohexyl)propane (BMACP). Other commonly used diamines may be isophoronediamine (IPDA) and 2,6-bis(aminomethyl)norbomane (BAMN). As examples of aromatic diacids, mention may be made of terephthalic (T) and isophthalic (I) acids.

The amorphous polyamide (B) may optionally contain at least one monomer chosen from:

α,Ω-aminocarboxylic acids,

aliphatic diacids,

aliphatic diamines,

these products were described above.

As examples of (B), mention may be made of the amorphous semi-aromatic polyamide PA-12/BMACM, TA/BMACM,IA synthesized by melt polycondensation using bis(3-methyl-4-aminocyclohexyl)methane (BMACM), lauryllactam (L12) and isophthalic acid and terephthalic acid (IA and TA). It would not be outside the scope of the invention if (B) were to be a blend of several amorphous polyamides.

With regard to the polyamides of the upper layer both in the first form and the second form, it is preferred to use polyamides in which the ratio of chain ends [NH₂]/[COOH] is >1. Advantageously, these polyamides are highly transparent, that is to say they have a transparency of 80% or higher light transmission on an object 2 mm in thickness at a wavelength of 560 nm (cf ISO 13468).

With regard to the substrate, this is advantageously either made of PP (polypropylene) or made of PA-6 or PA-6,6 or made of a styrene polymer, such as for example ABS. Depending on its nature, the lower layer and the optional intermediate layer are different.

We now consider the polypropylene substrate. The term “polypropylene”, for the substrate, denotes a polypropylene homopolymer or copolymer, PP blends and alloys and PP filled with glass and/or mineral fibres.

With regard to the lower layer, this is either a polypropylene homopolymer or copolymer or PP-based alloy or blend. As regards the central layer, this consists of one or more polymers acting as tie between the other two layers and being based on polyolefins or copolyolefins completely or partly grafted or copolymerized with an anhydride, epoxide or acid, preferably maleic anhydride. Advantageously, the central layer is made of a polyolefin completely or partly graft or copolymerized with an anhydride, epoxide or acid, preferably maleic anhydride. Preferably, the polyolefin is a PP homopolymer or copolymer.

In another form, the central layer is a PP/PE blend containing mostly PP, completely or partly grafted with anhydride, epoxide or acid, preferably maleic anhydride.

In another form, the central layer consists of a copolyolefin not essentially consisting of PP but adhering sufficiently to PP, taken from the family of copolymers of ethylene with an alkyl (meth)acrylate and with either acrylic acid or maleic anhydride or an epoxy.

In a variant, there is no central layer and the lower layer is made of polypropylene completely or partly grafted with an anhydride, epoxide or acid, preferably maleic anhydride.

Advantageously, the melting point of the lower layer, that of the upper layer and that of the optional central layer lie within a range of at most 50° C. and preferably at most 25° C.

We now consider the polyamide substrate. This is based on aliphatic polyphthalamides or polyamides, such as PA-6 or products resulting from the condensation of a diamine and a diacid each having no more than 8 carbon atoms, such as for example PA-6,6, PA-4,6, coPA-6/other monomer and coPA-6,6/other monomer. As examples of polyphthalamides, mention may be made of PA-6/6.T, PA-6,6/6.T, PA-6,6/6.I/6.T, PA-6.I/6.T, PA-9.T, PA-MXD.6, PA-6.I, blends and alloys thereof and versions thereof filled with glass and mineral fibres, etc. The lower layer is made of a polyamide from the same family as the polyamide of the substrate or from a family that can adhere well to the polyamide of the substrate. This polyamide is, for example, chosen from PA-6, PA-6,6, PA-4,6, polyphthalamides or alloys of these polyamides. The central layer consists of one or more polymers acting as tie between the other 2 layers.

Regarding more precisely the lower layer, this advantageously consists of polyamides in which the chain end ratio [NH₂]/[COOH] is greater than 1.

Advantageously, it consists of a polyamide identical or similar to that of the substrate to which the film will in the end be made to adhere. The term “similar polyamide” is understood to mean either a blend comprising mostly this polyamide relative to the other polymers or a copolymer consisting mostly of the same monomer as that of the substrate polyamide, it being possible, of course, for all these products to contain commonly used additives.

If the substrate is made of PA-6 or mostly PA-6, the lower layer consists of PA-6 or coPA-6/other monomer, the other monomer being in a very minor amount (<30%) in order to guarantee adhesion to the PA-6 substrate. The other monomer may either be a lactam (for example lauryllactam) or an α,Ω-aminocarboxylic acid different from caprolactam or a blend of a diamine and a diacid. Thus, the coPA-6/other monomer may be a coPA-6/12 (a caprolactam/lauryllactam copolymer) rich in 6 or a coPA-6/6,6, a copolymer of caprolactam, hexamethylenediamine and adipic acid rich in caprolactam.

If the substrate is made of PA-6,6 or mostly PA-6,6, the lower layer consists of PA-6,6 or coPA-6,6/other monomer, the other monomer being in a very minor amount (<30%) in order to guarantee adhesion to the PA-6,6 substrate. The other monomer may either be a lactam (for example lauryllactam) or an α,Ω-aminocarboxylic acid or a blend of a diamine and a diacid. Thus, the coPA-6,6/other monomer may be a coPA-6,6/12 (a copolymer of hexamethylenediamine, adipic acid and lauryllactam) rich in 6,6. It may also be a coPA-6,6/6 (a copolymer of hexamethylenediamine, adipic acid and caprolactam) rich in 6,6.

If the substrate is made of PA-4,6 or mostly PA-4,6, the lower layer consists of PA-4,6 or coPA-4,6/other monomer, the other monomer being in a very minor amount (<30%) in order to guarantee adhesion to the PA-4,6 substrate. The other monomer may be a lactam (for example lauryllactam) or an α,Ω-aminocarboxylic acid or a blend of a diamine and a diacid. Thus, the coPA-4,6/other monomer may be a coPA-4,6/12 (a copolymer of hexamethylenediamine, adipic acid and lauryllactam) rich in 6,6. It may also be a coPA-4,6/6 (a copolymer of hexamethylenediamine, adipic acid and caprolactam) rich in 6,6.

If the substrate is a polyphthalamide or mostly a polyphthalamide, the lower layer consists of coPA-6.I/other monomer or coPA-6.T/other monomer, the other monomer being in a very minor amount (<30%) in order to guarantee adhesion to the polyphthalamide substrate. The other monomer may be a lactam (for example lauryllactam) or an α,Ω-aminocarboxylic acid or a blend of a diamine and a diacid. Thus, the coPA-6.I/other monomer may be a coPA-6.I/12 (a copolymer of hexamethylenediamine, isophthalic acid and lauryllactam) rich in 6.I. It may also be a coPA-6.I/6 (a copolymer of hexamethylenediamine, isophthalic acid and caprolactam) rich in 6.I.

In another form the lower layer mostly consists of the same polyamide as the substrate and of a catalyzed polyamide, optionally with a plasticizer and optionally with an impact modifier.

If the substrate is an alloy of PA-6,6 and PPO (polyphenylene oxide), the lower layer consists of PA-6,6 or of a blend consisting mostly of PA-6,6.

If the substrate is made of PA-6 or mostly PA-6, the lower layer consists either of a PA-6/ABS blend containing mostly PA-6 or a PA-6/polycarbonate blend containing mostly PA-6.

In another form, the lower layer is a blend:

of a polyamide coming from the condensation either of a lactam or of an α,Ω-amino acid having at least 9 carbon atoms or of a diamine and of a diacid, at least one having at least 9 carbon atoms; and

of other polymers having chemical functional groups, such as maleic anhydride, which can react with the polyamide of the substrate.

By way of examples, mention may be made of blends of PA-12 and ethylene/alkyl (meth)acrylate/maleic anhydride copolymers.

In another form, the lower layer is a polyamide/ABS alloy.

Regarding more precisely the central layer, this consists of copolyamides, copolymers having polyamide blocks and polyether blocks, a functionalized polyolefin or blends of a polyamide and of a functionalized polyolefin or functionalized polymers advantageously chosen from styrene polymers.

With regard to the copolyamides, these consist of ≧C9 monomers (i.e. having 9 or more than 9 carbon atoms) of the polyamide of the upper layer and of ≦C8 monomers of the polyamide of the lower layer. For example, if the upper layer is based on PA-12 and the lower layer based on PA-6, the copolyamide of the central layer is a coPA-6/12 (a caprolactam/lauryllactam copolymer).

In an advantageous form this is a blend of two copolyamides, one containing mostly ≧C9 monomer and the other mostly ≦C8 monomer. Advantageously the ≧C9 monomer is a monomer present in the upper layer and the ≦C8 monomer is a monomer present in the lower layer.

In another advantageous form this is a blend of 2 copolyamides, one containing mostly ≧C9 monomer with a minor amount of ≦C8 monomer, the other containing mostly ≦C8 monomer with a minor amount of ≧C9 monomer, and these two copolyamides possess an identical ≧C9 comonomer and/or an identical ≦C8 comonomer. Advantageously, the ≧C9 monomer is a monomer present in the upper layer and the ≦C8 monomer is a monomer present in the lower layer.

For example, if the upper layer is based on PA-11 and the lower layer is based on PA-6, the copolyamide blend may be a coPA-12/6 rich in 12 (70% lauryllactam units)/coPA-6/12 rich in 6 (70% caprolactam units) 50/50 blend by weight.

For example, if the upper layer is based on PA-12 and the lower layer based on PA-6, the copolyamide blend may be a coPA-11/6 rich in 11 (70% aminoundecanoic acid units)/coPA-6/12 rich in 6 (70% caprolactam units) 50/50 blend by weight.

For example, if the upper layer is based on PA-12 and the lower layer based on PA-6, the copolyamide blend may be a coPA-12/6,10 rich in 12 (70% lauryllactam units)/coPA-6,10/6 rich in 6 (80% caprolactam units) 50/50 blend by weight.

For example, if the upper layer on PA-12 and the lower layer based on PA-6, the copolyamide blend may be a coPA-12/6 rich in 12 (70% lauryllactam units )/coPA-6/12 rich in 6 (80% caprolactam units) 50/50 blend by weight.

In a variant of the central layer consisting of a blend of two copolyamides, it is replaced by two adjacent layers, one comprising the copolyamide containing mostly ≧C9 monomer placed against the outer layer and the other comprising the copolyamide containing mostly ≦C8 monomer placed against the lower layer.

With regard to copolymers having polyamide blocks and polyether blocks, this is more precisely a blend of a copolymer having polyamide blocks and polyether blocks, with polyamide blocks consisting mostly of a ≧C9 monomer, and of another copolymer having polyamide blocks and polyether blocks, with polyamide blocks consisting mostly of a ≦C8 monomer. Advantageously, the polyether blocks are made of PTMG (polytetramethylene glycol).

For example, if the upper layer is based on PA-12 and the lower layer based on PA-6, the blend of copolymers having polyamides blocks and polyether blocks may be a copolymer having PA-12 blocks and PTMG blocks/copolymer having PA-6 blocks and PTMG blocks 50/50 blend by weight.

In a variant of the central layer consisting of a blend of copolymers having polyamide blocks and polyether blocks, it is replaced with two adjacent layers, one comprising the copolymer having polyamide blocks and polyether blocks, with polyamide blocks consisting mostly of a ≧C9 monomer placed against the outer layer and the other comprising the copolymer having polyamide blocks and polyether blocks with polyamide blocks consisting mostly of a ≦C8 monomer placed against the lower layer.

With regard to the functionalized polyolefins or polyamide/functionalized polyolefin blends, this is advantageously a blend of polyamide with other polymers, preferably polyolefins, these other polymers being completely or partly copolymerized or grafted by chemical functional groups that can react with the polyamides of the adjacent layers, these functional groups being anhydride, epoxide or acid, preferably maleic anhydride.

If the upper layer is based on PA-11 and the lower layer made of PA-6, then the central layer may be a blend comprising, by weight, 70% of the composition of the upper layer and 30% of a copolymer of ethylene with an alkyl (meth)acrylate, for example butyl acrylate, and maleic anhydride.

In another form, the central layer consists of polymers of the family comprising polypropylene homopolymers or copolymers and their blends and alloys, completely or partly grafted with an anhydride, preferably maleic anhydride.

In another form, the central layer consists of polymers from the family of (co)polyolefins not essentially PP, completely or partly grafted with an anhydride or copolymerized with an anhydride, preferably maleic anhydride.

In another form, the central layer consists of at least one copolymer of ethylene with an alkyl(meth)acrylate, preferably having from 4 to 12 carbon atoms (for example butyl acrylate), and maleic anhydride. It would not be outside the scope of the invention to replace the anhydride with acrylic acid.

In another form, the central layer consists of polymers from the family of (co)polyolefins grafted or copolymerized with an epoxide, in particular GMA. As examples, mention may be made of copolymers of ethylene with glycidyl methacrylate and optionally an alkyl (meth)acrylate preferably having from 4 to 12 carbon atoms (for example butyl acrylate).

In another form, the central layer consists of polymers from the family of polyolefins or copolymers of olefin/vinyl acetate/maleic anhydride. As examples, mention may be made of ethylene/vinyl acetate/maleic anhydride copolymers.

With regard to the functionalized polymers, the central layer consists of polymers grafted with maleic anhydride or another functional group that reacts with the PA chain ends of the adjacent layers.

In one advantageous form the central layer consists of polymers from the family of styrene polymers grafted with maleic-anhydride or another functional group that can react with the PA chain ends of the adjacent layers. As examples, mention may be made of block copolymers of the SBS type (polystyrene/polybutadiene/polystyrene triblock) optionally hydrogenated, these polymers being grafted by maleic andhydride.

In a variant, again in the case of the polyamide substrate, there is no intermediate (central) layer.

In one advantageous form the lower layer consists of a blend of a ≦C8 PA (ensuring adhesion to the ≦C8 PA substrate) with other polymers, preferably polyolefins, these polymers being completely or partly copolymerized or grafted by chemical functional groups that can react with the ≧C9 polyamides of the upper layer, these functional groups being an anhydride, epoxide or acid, preferably maleic anhydride.

For example, if the upper layer is based on PA-11 and the lower layer made of PA-6, the lower layer may be a blend, comprising, by weight, 65% PA-6, 25% HDPE and 10% maleic-anhydride-grafted polyethylene (MAH-g-PE). The PA-6 does not adhere to the PA-11, it being the MAH-g-PE that adheres to the PA-11.

In another advantageous form, the lower layer consists of a blend of a ≧C9 PA (ensuring adhesion to the ≧C9 PA upper layer) with other polymers, preferably polyolefins, these polymers being completely or partly copolymerized or grafted by chemical functional groups that can react with the ≦C8 polyamides of the substrate, these functional g being anhydride, epoxide or acid, preferably maleic anhydride.

For example, if the upper layer is based on PA-11 and the lower layer made of PA-6, then the lower layer may be a blend comprising, by weight, 70% of the composition of the upper layer and 30% of an ethylene/butyl acrylate/maleic anhydride copolymer (the PA-11 does not adhere to PA-6, it being the MAH copolymer that will adhere to the PA-6).

In another advantageous form, the lower layer consists of polymers (preferably polyolefins and better still a polypropylene homopolymer or copolymere) partly or completely copolymerized or grafted by chemical functional groups that can also react with the polyamides of the substrate, these functional groups being anhydride, epoxide or acid, preferably maleic anhydride. It is advantageous for these polymers to have a melting point close to that of the upper layer, that is to say the difference between them being less than 50° C. and preferably less than 25° C.

In another advantageous form, the lower layer consists of a blend of <C8 coPA (copolyamide) (the number of methylene CH₂ groups to the number of amide NCO groups of which is less than 8), such a coPA adhering to <C8 PAs, and of ≧C9 coPA (the number of methylene CH₂ groups to the number of amide NCO groups of which is greater than or equal to 9), which will ensure adhesion to a ≧C9 PA substrate, these coPAs adhering to ≧C9 PAs and being compatible with <C8 coPAs. In order for the lower layer to have melting point that is high enough and close to that of the upper layer, a predominant proportion of coPA rich in <C8 monomer will be taken and each of the coPAs will possess a monomer with a sufficiently predominant content for the melting point of these coPAs to differ by not more than 50° C., preferably 25° C., from that of the upper layer.

For example, if the upper layer is based on PA-12 and the substrate based on PA-6, the copolyamide blend may be a coPA-12/6 rich in 12 (70% lauryllactam units)/co-PA-6/12 rich in 6 (70% caprolactam units) 50/50 by weight blend.

We now consider the substrate made of a styrene polymer. By way of examples of styrene polymers, mention may be made of polystyrene, elastomer-modified polystyrene, styrene-acrylonitrile copolymers (SAN), elastomer-modified SAN, particularly ABS which is obtained, for example, by grafting (graft polymerization) of styrene and acrylonitrile on a polybutadiene or butadiene-acrylonitrile copolymer backbone, and blends of SAN and ABS. The abovementioned elastomers may be, for example, EPR (the abbreviation for ethylene-propylene rubber or ethylene-propylene elastomer), EPDM (the abbreviation for ethylene-propylene-diene rubber or ethylene-propylene-diene elastomer), polybutadiene, acrylonitrile-butadiene copolymer, polyisoprene or isoprene-acrylonitrile copolymer.

In the polymers that have just been mentioned, part of the styrene may be replaced with unsaturated monomers copolymerizable with styrene; by way of example, mention may be made of alpha-methylstyrene and (meth)acrylic esters. As examples of styrene copolymers, mention may also be made of chloropolystyrene, poly-alpha-methylstyrene, styrene-chlorostyrene copolymers, styrene-propylene copolymers, styrene-butadiene copolymers, styrene-isoprene copolymers, styrene-vinyl chloride copolymers, styrene-vinyl acetate copolymers, styrene-alkyl acrylate (methyl, ethyl, butyl, octyl or phenyl acrylate) copolymers, styrene-alkyl methacrylate (methyl, ethyl, butyl or phenyl methacrylate) copolymers, styrene-methyl chloroacrylate copolymers and styrene-acrylonitrile-alkyl acrylate copolymers. In these copolymers, the comonomer content will generally be up to 20% by weight. The present invention also relates to metallocene polystyrenes having a high melting point. It would not be outside the scope of the invention if it were a blend of two or more of the above polymers. These polymers may be filled with glass and mineral fibres. These polymers may be blended with polycarbonate (PC).

The lower layer is chosen from the same polymers as the substrate and the central layer consists of one or more polymers acting as tie between the other two layers.

Regarding more precisely the lower layer, this is advantageously made of ABS or MABS. In another form, it is made of a polycarbonate/ABS blend.

With regard to this central layer, this may be a polyamide having a monomer of the piperazine family, a functionalized polyolefin, a functionalized styrene polymer, an acrylic polymer or a polyurethane.

With regard to the polyamide having a monomer of the piperazine family, the expression “monomer of the piperazine family” is understood to mean diamines of the following formula: 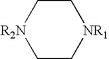
in which:

R₁ represents H or -Z1-NH₂ and Z1 represents an alkyl, a cycloalkyl or an aryl having up to 15 carbon atoms; and

R₂ represents H or -Z2-NH₂ and Z2 represents an alkyl, a cycloalkyl or an aryl having up to 15 carbon atoms,

R₁ and R₂ possibly being identical or different.

In one advantageous form, this is a copolyamide resulting from the condensation of a monomer of the piperazine family, a diacid and a lactam or an α,Ω-aminocarboxylic acid.

For example, if the upper layer is based on PA-11 and the lower layer made of ABS, the central layer is made of coPA-PIP.10/12 (condensation of piperazine, C10 diacid (sebacic acid) and lauryllactam).

With regard to functionalized polyolefins, the central layer consists of a copolymer of ethylene with an alkyl acrylate and a third monomer giving a carbonyl group, the whole preferably being functionalized by maleic anhydride.

For example, if the upper layer is based on PA-11 and the lower layer made of ABS, the central layer is made of MAH-functionalized E/BA/CO (a copolymer of ethylene, butyl acrylate and carbon monoxide and grafted by maleic anhydride).

In another form, the central layer consists of one or more copolymers of the E/VA/MAH (ethylene/vinyl acetate/maleic anhydride) type or E/VA type that is functionalized by an anhydride, epoxide or by another chemical group capable of reacting with the amine and/or acid chain ends of the polyamide of the upper layer.

For example, if the upper layer is based on PA-11 and the lower layer is made of ABS, the central layer is made of E/VA/MAH (Orevac® 9314 (10 wt % vinyl acetate) or Orevac® 9304 (25 wt % vinyl acetate)).

In another form, the central layer consists of one or more copolymers of the ethylene/alkyl (meth)acrylate/maleic anhydride type or ethylene/alkyl (meth)acrylate type which is grafted by an anhydride or epoxide or by another chemical group capable of reacting with the amine and/or acid chain ends of the polyamide of the upper layer. Among alkyl acrylates, those with light alkyls such as MA (methyl acrylate) and with a high content (>20% by weight of the copolymer) are preferred.

For example, if the upper layer is based on PA-11 and the lower layer made of ABS, the central layer is made of an ethylene/MA/GMA (25% MA, 8% GMA) copolymer, GMA denoting glycidyl methacrylate.

With regard to functionalized styrene polymers, the central layer consists of one or more styrene polymers functionalized by maleic anhydride or by another chemical group capable of reacting with the amine and/or acid chain ends of the polyamide of the upper layer.

For example, if the upper layer is based on PA-11 and the lower layer is made of ABS, the central layer is made of SMA (Bayere Cadon). SMA denotes a styrene/maleic anhydride copolymer.

With regard to acrylic polymers, the central layer consists of one or more acrylic polymers copolymerized or grafted by maleic anhydride or acrylic acid, or by another chemical group capable of reacting with the amine and/or acid chain ends of the polyamide of the upper layer.

For example, if the upper layer is based on PA-11 and the lower layer is made of ABS, the central layer is made of PMMA/AA/MAH, i.e. a PMMA having acid functional groups and acid anhydride functional groups (Oroglas HT 121).

In another form, the central layer consists of one or more polymers of the core-shell type, such as an all-acrylic polymer with a PMMA shell and a butyl acrylate core, such as Paralloid® EX3300 from Rohm & Haas, Paralloid® EXL3847 with an acrylic shell and an MBS core, or Paralloid® EXL 3691. MBS denotes methyl methacrylate/butadiene/styrene copolymers.

For example, if the upper layer is based on PA-11 and the lower layer made of ABS, the central layer is an EXL3847 core-shell.

With regard to the polyurethanes, the central layer consists of one or more TPU polymers, especially blended with PEBA, ABS or MABS polymers. TPU denotes thermoplastic polyurethanes. These TPUs consist of soft polyether blocks, which are residues of polyetherdiols, and of hard blocks (polyurethanes) that result from the reaction of at least one diisocyanate with at least one short diol. The short chain extender diol may be chosen from the group consisting of neopentyl glycol, cyclohexanedimethanol and aliphatic glycols of formula HO(CH2)ₙOH in which n is an integer ranging from 2 to 10. The polyurethane blocks and the polyether blocks are connected by links that result from the reaction of the isocyanate functional groups with the OH functional groups of the polyetherdiol. Mention may also be made of polyesterurethanes, for example those comprising diisocyanate units, units derived from amorphous diol polyesters and units derived from a short chain extender diol. They may contain plasticizers. The TPU may be blended with copolymers having polyamide blocks and polyether blocks, and/or with styrene resins.

For example, if the upper layer is based on PA-11 and the lower layer is made of ABS, the central layer is an Elastollan® 1185A ether-based TPU.

In a variant, again in the case of the substrate made of styrene polymer, there is no intermediate (central) layer. The lower layer has a melting point close to that of the upper layer—the difference must not exceed 50° C., preferably 25° C.

In one advantageous form, the lower layer consists of one or more styrene polymers, preferably ABS or SAN or ASA (an acrylonitrile/styrene/alkyl acrylate copolymer), completely or partly functionalized by a chemical group capable of reacting with an amine (or carboxylic acid) group of polyamide, such as an anhydride or epoxide, preferably maleic anhydride.

For example, if the upper layer is based on PA-11 and the substrate is made of ABS, the lower layer is a blend of ABS and maleic-anhydride-grafted ABS.

In another form, the lower layer consists of a blend of ≧C9 polyamides with 10 to 50% of one or more styrene polymers, preferably ABS or SAN or ASA, completely or partly functionalized by a chemical group capable of reacting with an amine (or carboxylic acid) group of polyamide, such as an anhydride or epoxide, preferably maleic anhydride.

In another form, the lower layer consists of a blend of ≧C9 polyamides with 10 to 50% of one or more copolymers of ethylene and of a polar monomer of the alkyl acrylate or vinyl acetate type, completely or partly functionalized (by copolymerization or grafting) by a chemical group capable of reacting with an amine (or carboxylic acid) group of polyamide, such as an anhydride or epoxide, preferably maleic anhydride.

For example, if the upper layer is based on PA-11 and the substrate is made of ABS, the lower layer is made of E/VA/MAH (Orevac® 9304 containing 25 wt % vinyl acetate).

In another form, the lower layer consists of an alloy of ≧C9 polyamides with 10 to 50% of one or more copolyamides comprising a monomer of the piperazine family.

For example, if the upper layer is based on PA-11 and the substrate is made of ABS, the lower layer is a blend consisting of 65% PA-11 and 35% coPA-PIP.10/12 by weight.

In another form, the lower layer consists of polar copolyolefins containing an alkyl acrylate or vinyl acetate, completely or partly functionalized or copolymerized with an anhydride, for example maleic anhydride, or an epoxide, or any other group that can react with the amine or acid chain ends of the upper polyamide layer. High alkyl acrylate or vinyl acetate contents are preferred. Among alkyl acrylates, those consisting of light acrylates such as methyl acrylate, are preferred.

For example, if the upper layer is based on PA-11 and the substrate is made of ABS, the lower layer is an ethylene/MA/GMA copolymer (containing 25% MA and 8% GMA), GMA denoting glycidyl methacrylate.

In another form, the lower layer consists of one or more TPU polymers, optionally blended with copolymers having polyamide blocks and polyether blocks, or with ABS or MABS.

With regard to the structures of the invention, these are advantageously produced by coextrusion and then the structure is advantageously overmoulded, that is to say placed in the mould of an injection-moulding machine in which a polymer substrate will be injected onto the lower layer, the upper layer being placed against the wall of the mould. Advantageously, the structure will firstly be thermoformed and then overmoulded, that is to say placed in the mould of an injection-moulding machine in which a polymer substrate will be injected onto the lower layer.

Next, the structure is made to adhere to a substrate during an operation carried out hot, for the purchase of obtaining a finished part sufficiently thick and/or rigid to be used.

The central layer may itself consist of several layers adhering to one another, the outermost layers of which adhere to the upper and lower layers respectively.

With regard to the techniques for combining the structure with the substrates, mention may also be made of lamination and hot pressing.

The polymers of the various layers are advantageously chosen from those that can be extruded in sheet form, that is to say typically rather viscous polymers, and therefore those of quasi-high molecular weight.

In the case of sublimation decoration, the face undergoing sublimation is typically flame-brushed beforehand so that the subsequent adhesion to the substrate is better.

The thicknesses of the layers are for example 200/300/100 μm. Of course, these thicknesses may be varied in order to adjust the compromise of properties. For example, the thickness of the central layer may be increased in order to increase the flexibility, or vice versa.

### EXAMPLES

The following products were used:

| | |
|---|---|
| BESN0 24 | PA-11 (Atofina Rilsan BESN0 24 TL CC) |
| TLCC | |
| PA-12 | nylon-12 polyamide of about 50000 \overline{M}_{w} (weight-average molecular |
| | weight), Rilsan AESN0 TL from Atofina |
| PA-11 | nylon-11 polyamide of about 50000 \overline{M}_{w}, Rilsan BESN0 TL from Atofina |
| PA-10, 12 | nylon-10, 12 |
| CX7323 | Vestamid CX7323 from Degussa |
| PA- | Polyamide/PACM.12 of the Trogamid CX7323 type from Degussa |
| PACM.12 | |
| TR90LX | Grilamid TR90LX from Ems |
| TR90UV | TR90UV Grilamid from Ems |
| PA- | polyamide-BMACM.12, also called polyamide-MACM.12 |
| BMACM.12 | |
| PA-11 No. 6 | Composition comprising: |
| | 65 parts of nylon-11 polyamide of 45000 to 55000 \overline{M}_{w}; |
| | 25 parts of IPDA.10/12, resulting from condensation of |
| | isophoronediamine, C10 (sebacic) acid and lauryllactam; |
| | 10 parts of a copolymer having PA-12 blocks of 5000 \overline{M}ₙ and PTMG |
| | blocks of 650 \overline{M}ₙ and an MFI of 4 to 10 (g/10 min at 235° C./1 kg), with at |
| | most 0.2 parts of the stabiliser Tinuvin 312 from Ciba-Geigy and 0.2 parts |
| | of Tinuvin 770 from Ciba-Geigy |
| PP No. 1 | A polypropylene of 2 MFI (230° C./2.16 kg), Appryl 3020GN3 |
| gPP | A 1% maleic-anhydride-grafted polypropylene, Orevac CA100 from |
| | Atofina |
| gPP18729 | MAH-grafted polypropylene, Orevac 18729 from Atofina |
| coPP No. 1 | polypropylene copolymer, PPC 3640 from Atofina |
| PP1 | polypropylene PPH10060 from Atofina |
| GF-PP | polypropylene filled with 30% glass fibre |
| grey MB1 | metallic grey PB-based masterbatch, Clariant PLS2130026 |
| LGF-PP | polypropylene filled with long glass fibre, Pryltex V4030 HL 12 from |
| | Atofina |
| gPE | polyethylene of 0.910 density, 4 MFI (190° C./2.16 kg), grafted with 1% maleic |
| | anhydride |
| PE No. 1 | polyethylene of 0.910 density and 4 MFI (190° C./2.16 kg) |
| gPE18370 | MAH-grafted polyethylene, Orevac 18370 from Atofina |
| E/EHA/MAH | copolymer of ethylene/2-ethylhexyl acrylate (30 wt %)/maleic anhydride |
| | (1.5 wt %) of 5.5 MFI (190° C./2.16 kg) |
| coPA-6/66 | 6/66 copolyamide, Ultramid C4 from BASF, melting point 195° C. |
| C4 | |
| PA-6/PE | Orgalloy LE60LM, melting point 220° C. |
| alloy | |
| coPA-6-PE | alloy with a coPA-6/66 matrix, Orgalloy LEC601 from Atofina, melting |
| alloy | point 195° C. |
| grey MB2 | metal grey coPA-6/66-based master batch, AES3132003 from Clariant |
| GF PA-6 | nylon-6 polyamide filled with glass fibre (20%) and mineral fibre (20%), |
| | Akulon HGM 44 from DSM |
| coPA- | copolymer with PA-12 blocks and PTMG blocks, Pebax 5533 SA01 from |
| 12/PTMG | Atofina |
| coPA- | copolymer with PA-6 blocks and PTMG blocks, Pebax 1878 SA01 from |
| 6/PTMG | Atofina |
| E/BA/MAH | ethylene/n-butyl acrylate (6 wt %)/maleic anhydride (3 wt %) copolymer |
| | of 5 MFI (190° C./2.16 kg) |
| E/VA/MAH | ethylene/vinyl acetate (14 wt %)/maleic anhydride (1.5 wt %) copolymer of |
| | 2 MFI (190° C./2.16 kg) |
| coPA- | piperazine.10/12 copolyamide containing 20 wt % lauryllactam units |
| PIP.10/12 | |
| E/BA/CO | ethylene/butyl acrylate/MAH-functionalized carbonyl copolymer, |
| | Fusabond MG 423 D from DuPont |
| 9304 | ethylene/vinyl acetate (26 wt %)/maleic anhydride (1.5 wt %) copolymer of |
| | 7 MFI (190° C./2.16 kg) |
| E/MA/GMA | ethylene/methyl acrylate (30 wt %)/glycidyl methacrylate (8 wt %) |
| | copolymer of 5 MFI (190° C./2.16 kg) |
| SMA | styrene/maleic anhydride copolymer of the Cadon type from Bayer |
| PMMA-A | methyl methacrylate/acrylic acid copolymer, Oraglas HT121 from |
| | Atoglas |
| EXL3847 | acrylic core-shell polymer, Paralloid EXL3847 from Rohm & Hass |
| TPU1185A | polyurethane, Elastollan 1185A from Elastogran |
| TPUC90A | polyurethane, Elastollan C90A from Elastogran |
| ABS | acrylonitrile/butadiene/styrene copolymer |
| MAH-g-ABS | maleic-anhydride-grafted acrylonitrile/butadiene/styrene copolymer |
| MABS | methacrylate/acrylonitrile/butadiene/styrene copolymer, Terlux 2802 TR from |
| | BASF |
| Triax | ABS alloy, Triax 1120 from Bayer |

Terms appearing in the tables:

| | |
|---|---|
| Up. layer | Upper layer of the structure or external face |
| Low. layer | Lower layer of the structure, or face bonded |
| | to the substrate |
| Scratch | Ability to resist scratching and to maintain |
| resistance | a shiny appearance |
| Impact | Ability to resist an impact, a sharp blow, a |
| resistance | strong vibration, in particular |
| | at low temperature |
| Flexibility | Flexibility of the sheet |
| Sublim. | Ability to be easily decorated by |
| | sublimation (good transfer of the |
| | pigments and very clear decoration) |
| Screen print | Ability to bond well to screen-printing inks |
| UV resistance | Ability to withstand UV radiation |
| Creep | Ability to withstand various hot operations during |
| resistance | manufacture of an object, without unacceptable |
| | deformation of the structure |

+++ = very satisfactory;
++ = satisfactory;
+ = quite satisfactory;
0 = average;
− quite unsatisfactory;
−− = unsatisfactory,
−−− = very unsatisfactory.

TABLE 1

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 1 | PA-11 No. 6 | PP No. 1 + gPP | coPP No.1 + grey MB1 | PP1 | +++ | +++ | +++ | +++ |
| 2 | PA-11 No. 6 | gPP18729 | ″ | ″ | +++ | +++ | +++ | +++ |
| 403 | PA-11 No. 6 | PE No. 1 + gPE | ″ | ″ | +++ | +++ | +++ | +++ |
| 4 | PA-11 No. 6 | gPE18370 | ″ | ″ | +++ | +++ | +++ | +++ |
| 5 | PA-11 No. 6 | E/EHA/MAH | ″ | ″ | +++ | +++ | +++ | +++ |
| 6 | BESNO 24 | gPP18729 | ″ | ″ | +++ | +++ | +++ | ++ |
| | TLCC | | | | | | | |
| 7 | PA-11 No. 6 | ″ | ″ | GF-PP | +++ | +++ | +++ | +++ |
| 8 | PA-11 No. 6 | ″ | ″ | LGF-PP | +++ | +++ | +++ | +++ |

| | Endurance | | | | | | | |
|---|---|---|---|---|---|---|---|---|
| | Up. layer | | | | | | Low. stop | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 1 | +++ | +++ | +++ | +++ | ++ | ++ | +++ | +++ |
| 2 | +++ | +++ | +++ | +++ | ++ | ++ | +++ | +++ |
| 403 | +++ | +++ | +++ | +++ | ++ | +++ | +++ | +++ |
| 4 | +++ | +++ | +++ | +++ | ++ | +++ | +++ | +++ |
| 5 | +++ | +++ | +++ | +++ | ++ | ++ | +++ | ++ |
| 6 | +++ | +++ | +++ | +++ | ++ | ++ | +++ | +++ |
| 7 | +++ | +++ | +++ | +++ | ++ | ++ | +++ | +++ |
| 8 | +++ | +++ | +++ | +++ | ++ | ++ | +++ | +++ |

TABLE 2

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 9 | PA-11 No. 6 | None | gPP18729 + grey MB1 | PP1 | +++ | +++ | +++ | +++ |
| 10 | PA-11 | gPP18729 | coPP No. 1 + grey MB1 | PP | ++ | 0 | ++ | + |
| 11 | PA-12 | ″ | ″ | ″ | + | 0 | ++ | + |
| 12 | PA-12 + 15% | ″ | ″ | ″ | ++ | 0 | ++ | + |
| | PA-10, 12 | | | | | | | |
| 13 | CX7323 | ″ | ″ | ″ | +++ | 0 | +++ | |
| 14 | PA-PACM. 12 | ″ | ″ | ″ | +++ | ++ | +++ | |
| 15 | TR90LX | ″ | ″ | ″ | +++ | + | +++ | |
| 16 | TR90UV | ″ | ″ | ″ | +++ | 0 | +++ | |
| 17 | PA- | ″ | ″ | ″ | +++ | ++ | +++ | |
| | BMACM.12 | | | | | | | |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 9 | +++ | +++ | +++ | +++ | ++ | ++ | +++ | +++ |
| 10 | ++ | +++ | +++ | ++ | ++ | ++ | +++ | +++ |
| 11 | + | ++ | +++ | ++ | + | ++ | +++ | +++ |
| 12 | + | ++ | +++ | ++ | + | ++ | +++ | +++ |
| 13 | ++ | ++ | ++ | − | + | ++ | +++ | |
| 14 | ++ | ++ | ++ | − | −− | ++ | +++ | |
| 15 | | | ++ | − | −− | ++ | +++ | |
| 16 | | | ++ | − | −− | ++ | +++ | |
| 17 | | | ++ | − | −− | ++ | +++ | |

TABLE 3

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 19 | PA-11 No. 6 | gPP18729 | coPA-6/66 C4 + grey MB2 | GF PA-6 | +++ | +++ | +++ | +++ |
| 20 | ″ | ″ | PA-6/PE alloy + grey MB1 | ″ | +++ | +++ | +++ | +++ |
| 21 | ″ | ″ | coPA-6/PE alloy + grey MB1 | ″ | +++ | +++ | +++ | +++ |
| 22 | ″ | gPE18370 | ″ | ″ | +++ | +++ | +++ | +++ |
| 23 | ″ | E/BA/MAH | ″ | ″ | +++ | +++ | +++ | +++ |
| 24 | ″ | E/VA/MAH | ″ | ″ | +++ | +++ | +++ | +++ |
| 25 | ″ | None | ″ | ″ | +++ | +++ | +++ | +++ |
| 26 | ″ | None | PA-11 No. 6 + 30% | ″ | +++ | +++ | +++ | +++ |
| | | | E/BA/MAH | | | | | |
| 27 | ″ | None | gPP18729 + grey MB1 | ″ | +++ | +++ | +++ | +++ |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 19 | +++ | +++ | +++ | +++ | ++ | ++ | +++ | + |
| 20 | +++ | +++ | +++ | ++ | ++ | ++ | +++ | +++ |
| 21 | +++ | +++ | +++ | +++ | ++ | ++ | +++ | +++ |
| 22 | +++ | +++ | +++ | +++ | ++ | +++ | +++ | +++ |
| 23 | +++ | +++ | +++ | + | ++ | ++ | +++ | +++ |
| 24 | +++ | +++ | +++ | + | ++ | ++ | +++ | +++ |
| 25 | +++ | +++ | +++ | +++ | ++ | ++ | +++ | +++ |
| 26 | +++ | +++ | +++ | +++ | ++ | +++ | ++ | + |
| 27 | +++ | +++ | +++ | +++ | ++ | ++ | ++ | +++ |

TABLE 4

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 28 | PA-11 No. 6 | None | coPA-6/PE alloy + grey MB1 | GF PA-6 | +++ | +++ | +++ | +++ |
| 29 | ″ | coPA-12/6 rich | coPA-6/66 C4 + grey MB2 | ″ | +++ | +++ | +++ | +++ |
| | | in 12 (70%) + | | | | | | |
| | | coPA-6/12 rich | | | | | | |
| | | in 6 (70%) | | | | | | |
| 30 | ″ | coPa-11/6 rich | ″ | ″ | +++ | +++ | +++ | +++ |
| | | in 12 (70%) + | | | | | | |
| | | coPA-6/12 rich | | | | | | |
| | | in 6 (70%) | | | | | | |
| 31 | ″ | coPA-12/PTMG | ″ | ″ | +++ | +++ | +++ | +++ |
| | | (PEBAX 12) + | | | | | | |
| | | coPA-6/PTMG | | | | | | |
| | | (PEBAX 6) | | | | | | |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 28 | +++ | +++ | +++ | +++ | ++ | ++ | +++ | +++ |
| 29 | +++ | +++ | +++ | +++ | ++ | ++ | +++ | + |
| 30 | +++ | +++ | +++ | +++ | ++ | ++ | +++ | + |
| 31 | +++ | +++ | +++ | +++ | ++ | ++ | +++ | + |

TABLE 5

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 32 | PA-11 No. 6 | coPA-12/6, 10 | coPA-6/66 C4 + grey MB2 | GF PA-6 | +++ | +++ | +++ | +++ |
| | | (70% of 12) + | | | | | | |
| | | CoPA-6, 10/6 | | | | | | |
| | | (70% of 6) | | | | | | |
| 33 | ″ | PA-11 No. 6 + | ″ | ″ | +++ | +++ | +++ | +++ |
| | | 30% E/BA/MAH | | | | | | |
| 34 | PA-11 No. 6 + | None | None | ″ | ++ | ++ | +++ | +++ |
| | 30% E/BA/MAH | | | | | | | |
| 35 | PA-11 No. 6 | None | coPA-12/6 rich | ″ | +++ | +++ | +++ | +++ |
| | | | in 12 (70%) + coPA- | | | | | |
| | | | 6/12 rich | | | | | |
| | | | in 6 (70%) | | | | | |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 32 | +++ | +++ | +++ | +++ | ++ | ++ | +++ | + |
| 33 | +++ | +++ | +++ | +++ | ++ | + | +++ | + |
| 34 | ++ | +++ | +++ | +++ | + | | + | ++ |
| 35 | +++ | +++ | +++ | +++ | ++ | ++ | +++ | + |

TABLE 6

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 37 | PA-11 No. 6 | coPA- | ABS | ABS | +++ | +++ | +++ | ++ |
| | | PIP.10/12 | | | | | | |
| 38 | PA-11 No. 6 | E/BA/CO | ABS | ABS | +++ | +++ | +++ | ++ |
| 39 | PA-11 No. 6 | E/VA/MAH | ABS | ABS | +++ | +++ | +++ | ++ |
| 40 | PA-11 No. 6 | 9304 | ABS | ABS | +++ | +++ | +++ | ++ |
| 41 | PA-11 No. 6 | E/MA/GMA | ABS | ABS | +++ | +++ | +++ | ++ |
| 42 | PA-11 No. 6 | SMA | ABS | ABS | +++ | +++ | +++ | ++ |
| 43 | PA-11 No. 6 | PMMA-A | ABS | ABS | +++ | +++ | +++ | ++ |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 37 | +++ | +++ | +++ | +++ | ++ | ++ | +++ | |
| 38 | +++ | +++ | +++ | +++ | ++ | ++ | +++ | |
| 39 | +++ | +++ | +++ | +++ | ++ | + | +++ | |
| 40 | +++ | +++ | +++ | +++ | ++ | ++ | +++ | |
| 41 | +++ | +++ | +++ | +++ | ++ | + | +++ | |
| 42 | +++ | + | +++ | ++ | ++ | ++ | +++ | |
| 43 | +++ | + | +++ | + | ++ | + | +++ | |

TABLE 7

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 44 | PA-11 No. 6 | EXL3847 | ABS | ABS | +++ | +++ | +++ | ++ |
| 45 | PA-11 No. 6 | TPU1185A | ABS | ABS | +++ | +++ | +++ | ++ |
| 46 | PA-11 No. 6 | TPU1185A | MABS | ABS | +++ | +++ | +++ | ++ |
| 47 | PA-11 No. 6 | TPUC90A | MABS | ABS | +++ | +++ | +++ | ++ |
| 48 | PA-11 No. 6 | None | MAH-g ABS + ABS | ABS | +++ | +++ | +++ | ++ |
| 49 | PA-11 No. 6 | None | Triax | ABS | +++ | +++ | +++ | ++ |
| 50 | PA-11 No. 6 | None | PA-11 No. 6 + 30% | ABS | +++ | +++ | +++ | ++ |
| | | | 9304 | | | | | |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 44 | +++ | +++ | +++ | +++ | ++ | + | +++ | |
| 45 | +++ | +++ | +++ | +++ | ++ | ++ | +++ | |
| 46 | +++ | ++ | +++ | +++ | ++ | ++ | ++ | |
| 47 | +++ | ++ | +++ | +++ | ++ | ++ | ++ | |
| 48 | +++ | +++ | +++ | +++ | ++ | ++ | +++ | |
| 49 | +++ | +++ | +++ | ++ | ++ | + | ++ | |
| 50 | +++ | +++ | +++ | ++ | ++ | +++ | + | |

TABLE 8

| | | | | | Decoration | | | |
|---|---|---|---|---|---|---|---|---|
| | | | | | Up. layer | | Endurance | |
| | Finished part | | | | transparency | | Up. layer UV | Overall UV |
| | Structure | | | | and colour | Up. layer | resistance | resistance |
| Example | Up. layer | Central layer | Low. layer | Substrate | rendering | grain take-up | (yellowing) | (yellowing) |
| 51 | PA-11 No. 6 | None | PA-11 No. 6 + 35% | ABS | +++ | +++ | +++ | ++ |
| | | | coPA- | | | | | |
| | | | PIP. 10/12 | | | | | |
| 52 | PA-11 No. 6 | None | E/MA/GMA | ABS | +++ | +++ | +++ | ++ |
| 53 | PA-11 No. 6 | None | TPU1185A | ABS | +++ | +++ | +++ | ++ |
| 54 | PA-11 No. 6 | None | TPUC90A (55%) + | ABS | +++ | +++ | +++ | ++ |
| | | | MABS (45%) | | | | | |
| 55 | PA-11 No. 6 | TPU1185A | TPUC90A (55%) + | ABS | +++ | +++ | +++ | ++ |
| | | | MABS (45%) | | | | | |

| | Endurance | | | | | | | |
|---|---|---|---|---|---|---|---|---|
| | Up. layer | | | | | | Low. | |
| | knock & | | Up. layer | | | | layer | |
| | scratch | Impact | chemical | | Up. layer | Interlayer | adhesion to | Easy sheet |
| Example | resistance | resistance | resistance | Thermoformability | sublimation | adhesion | substrate | processing? |
| 51 | +++ | +++ | +++ | +++ | ++ | +++ | + | |
| 52 | +++ | +++ | +++ | +++ | ++ | ++ | + | |
| 53 | +++ | +++ | +++ | +++ | ++ | +++ | + | |
| 54 | +++ | +++ | +++ | +++ | ++ | ++ | + | |
| 55 | +++ | +++ | +++ | +++ | ++ | +++ | + | |

What is claimed is

1. A polyamide-based multilayer structure comprising in succession:
a) an upper layer made of a transparent polyamide coming from the condensation:
either of a lactam or of an α,Ω-amino acid having at least 9 carbon atoms,
or of a diamine and of a diacid, at least one having at least 9 carbon atoms;
b) a lower layer capable of adhering to the substrate; and
c) optionally, an intermediate tie layer between the upper layer and the lower layer,
wherein each of the layers exhibits thermomechanical behaviour (strength as a function of temperature) sufficiently similar to allow the structure to be easily formed under the effect of the temperature.

2. The structure according to claim 1, wherein the polyamide of the upper layer results from the condensation of at least one diamine chosen from aliphatic, aromatic, arylaliphatic and cycloaliphatic diamines, and of at least one diacid chosen from aliphatic, aromatic, arylaliphatic and cycloaliphatic diacids; wherein at least one of the diamines or diacids is aromatic, arylaliphatic or cycloaliphatic.

3. The structure according to claim 2, wherein the polyamide comes from the condensation of at least one aromatic diacid, of a diamine and optionally of a lactam, or of an α,Ω-amino acid.

4. The structure according to claim 2, in which the polyamide is a transparent amorphous polyamide that result from the condensation:
of at least one diamine chosen from aromatic, arylaliphatic and cycloaliphatic diamines, and
of an aliphatic diacid having at least 8 carbon atoms.

5. The structure according to claim 4, wherein said aliphatic diacid has at least 9 carbon atoms.

6. The structure according to claim 1, wherein the polyamide of the upper layer is an aliphatic semicrystalline polyamide chosen from PA-11, PA-12, the aliphatic polyamides resulting from the condensation of an aliphatic diamine having from 6 to 12 carbon atoms and of an aliphatic diacid having from 9 to 12 carbon atoms, and 11/12 copolyamides having either more than 90% 11 units or more than 90% 12 units.

7. The structure according to claim 1, wherein the polyamide of the upper layer is a microcrystalline polyamide.

8. The structure according to claim 7, wherein the microcrystalline polyamide is one whose T_{g} is between 40° C. and 90° C. and whose Tₘ is between 150° C. and 200° C., whose degree of crystallinity is greater than 10% (1st DSC heating according to ISO 11357 at 40° C./min) and whose melting enthalpy is greater than 25 J/g (1st DSC heating according to ISO 11357 at 40° C./min).

9. The structure according to claim 8, wherein the microcrystalline polyamide has a transparent composition comprising, by weight, the total being 100%:
a) 5 to 40% of an amorphous polyamide (B) that results essentially from the condensation:
1) either of at least one diamine chosen from cycloaliphatic diamines and aliphatic diamines and of at least one diacid, chosen from cycloaliphatic diacids and aliphatic diacids, at least one of these diamine or diacid units being cycloaliphatic;
2) of a cycloaliphatic α,Ω-aminocarboxylic acid; or
3) of a combination of these 1) and 2); and
4) optionally of at least one monomer chosen from α,Ω-amino-carboxylic acids or the possible corresponding lactams, aliphatic diacids and aliphatic diamines;
b) 0 to 40% of a flexible polyamide (C) chosen from copolymers having polyamide blocks and polyether blocks, and copolyamides;
c) 0 to 20% of a compatibilizer (D) for (A) and (B);
d) 0 to 40% of a flexible modifier (M);
with the condition that (C)+(D)+(M) is between 0 and 50%;
and the remainder to 100% of a semicrystalline polyamide (A).

10. The structure according to claim 8, wherein the microcrystalline polyamide has a transparent composition comprising, by weight, the total being 100%:
a) 5 to 40% of an amorphous polyamide (B) that results essentially from the condensation of at least one optionally cycloaliphatic diamine, of at least one aromatic diacid and optionally of at least one monomer chosen from:
α,Ω-aminocarboxylic acids,
aliphatic diacids,
aliphatic diamines;
b) 0 to 40% of a flexible polymer (C) chosen from copolymers having polyamide blocks and polyether blocks, and copolyamides;
c) 0 to 20% of a compatibilizer (D) for (A) and (B),
d) (C)+(D) is between 2 and 50%;
with the condition that (B)+(C)+(D) is not less than 30%,
the balance to 100% of a semicrystalline polyamide (A).

11. The structure according to claim 9, wherein the polyamide (A) is PA-11 or PA-12.

12. The structure according to claim 1, wherein the polyamide of the upper layer is such that the [NH₂]/[COOH] chain end ratio is greater than 1.

13. The structure according to claim 1, in which the polyamide of the upper layer is highly transparent, having a transparency of 80% or higher light transmission on an object 2 mm in thickness at a wavelength of 560 nm (cf. ISO 13468).

14. The structure according to claim 1, in which the substrate is either made of PP (polypropylene), PA-6, PA-6,6 or of a styrene polymer.

15. The structure according to claim 1, wherein the various layers exhibit comparable flexibility and mechanical characteristics, when hot, during the thermoforming operation.
